(19) United States
(12) Patent Application Publication
(10) Pub. No.: US 2015/0266119 A1
(43) Pub. Date: Sep. 24, 2015

(54) Saw Blade with Alternatingly Oriented Teeth Groupings

(71) Applicant: Scott Louis Christensen, Yucaipa, CA (US)

(72) Inventor: Scott Louis Christensen, Yucaipa, CA (US)

(73) Assignee: RYCOUR LLC, Yucaipa, CA (US)

(21) Appl. No.: 14/631,138

(22) Filed: Feb. 25, 2015

Related U.S. Application Data
(60) Provisional application No. 61/955,611, filed on Mar. 19, 2014.

(51) Int. Cl. B23D 61/12; B27B 33/10

(52) U.S. Cl. CPC B23D 61/121; B27B 33/10; B23D 61/128

(57) ABSTRACT

A saw blade with alternatingly oriented teeth groupings has a plurality of forward-oriented teeth groupings which are oriented toward the front end of the blade and a plurality of rearward-oriented teeth groupings which are oriented toward the rear end of the blade. The forward-oriented teeth groupings and the rearward-oriented teeth groupings alternate along the cutting edge of the blade, and traverse a specified length along the cutting edge corresponding to the stroke length of the reciprocating saw the blade is to be utilized with.

The current application claims a priority to the U.S. Provisional Patent application Ser. No. 61/955,611 filed on Mar. 19, 2014.

### FIELD OF THE INVENTION

The present invention relates generally to tools. More particularly, the present invention relates to reciprocating saw blades.

### BACKGROUND OF THE INVENTION

The reciprocating saw is a powered saw that is commonly used in construction and demolition work. The reciprocating saw is particularly useful for cutting through wood, drywall, metal pipes, and pipes. The thin elongated blade of the reciprocating saw allows the user to access and cut through materials in difficult to reach locations. Reciprocating saws, as their name suggests, utilize a reciprocating mechanism that extends the blade outward before drawing the blade inward in a push and pull motion. The cutting effectiveness of reciprocating saws may be increased through the use of an orbital action. An orbital action generates a reciprocating motion of the blade that causes the serrated edge of the saw blade to cycle in an oval pattern and come into contact with the cutting surface. The additional up and down motion complements the original push-pull motion of the saw blade in order to increase the effectiveness of the reciprocating saw. Individual models of reciprocating saws incorporate a number of unique features such as variable speed and cordless design. A wide variety of reciprocating saw blades is available with the blades generally being categorized based on the type of material that the user desires to cut. As previously discussed, reciprocating saw blades are available in variants for wood cutting, drywall cutting, metal cutting, and pipe cutting. The present invention seeks to enhance and improve upon current and conventional designs of reciprocating saw blades for further increasing the cutting effectiveness of reciprocating saws.

The present invention is a saw blade for reciprocating saws that incorporates an arrangement of teeth for increasing the cutting effectiveness of reciprocating saws. In the preferred embodiment of the present invention, the saw blade comprises an arrangement of teeth in which the teeth are positioned facing backward or forward in intervals. The orientation of the saw blade teeth reverse in intervals that correspond approximately to the length of each stroke that a reciprocating saw makes during use. In the preferred embodiment of the present invention, the arrangement of saw blade teeth is such that the rear end teeth of the saw blade are oriented backward toward the rear end of the saw blade. The teeth extend toward the front end of the saw blade in this backward orientation. The teeth then reverse direction and are oriented forward toward the front end of the saw blade approximately one length of a reciprocating saw stroke. The reversing arrangement of the saw blade teeth continues along the entirety of the length of the cutting edge of the saw blade. The saw blade features a standardized design that is common to most conventional reciprocating saw blades and may be installed and used in the same manner as conventional reciprocating saw blades. As such, the reciprocating saw blade features a thin elongated design with a mounting point that allows a user to install the saw blade into the corresponding front slot within the shoe of a reciprocating saw.

The object of the present invention is to increase the cutting effectiveness of reciprocating saws through the introduction of a unique saw blade design. Because the saw blade teeth reverse direction in intervals that correspond approximately to the length of a reciprocating saw stroke, the reciprocating saw is able to more effectively cut through various materials during use.

### BRIEF DESCRIPTION OF THE DRAWINGS

FIG. 1 is a perspective view of the present invention.

FIG. 2 is a side view of an embodiment of present invention comprising two mounting points.

FIG. 3 is a side view of the present invention illustrating the tooth groupings.

FIG. 4 is a detailed view of the present invention illustrating the tooth groupings.

FIG. 5 is detailed view of the present invention defining angles for the tooth groupings.

FIG. 6 is a bottom view of the present invention showing lateral skewing of the teeth.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a saw blade designed primarily for use with a reciprocating type saw featuring alternating groups of forward and rearward facing teeth.

The teeth groupings switch direction in intervals that correspond approximately to the length of a reciprocating saw stroke. The alternating arrangement of teeth is intended to facilitate more effective cutting of material compared to typical, uniformly toothed saw blades due to variation of the type of tooth in contact with the material to be cut on the forward stroke versus the reverse stroke.

The present invention is a saw blade that features a physical design that is similar to those of conventional reciprocating saw blades and as such may be installed and utilized in a similar manner. As a result, the length, thickness, and other design aspects of the saw blade are similar to those of conventional reciprocating saw blades. The present invention is not limited with respect to the specific material of the saw blade. A material such as, but not limited to, spring steel is suitable for the saw blade of the present invention due to the material's resistance to snapping or shattering. Spring steel is also suitable for absorbing shock and as such is well-suited for use in a reciprocating saw blade. It is important to note that the material of the saw blade of the present invention may vary based on the specific cutting application that is required of the saw blade. For example, the saw blade material may vary based on the type of material that the user desires to cut.

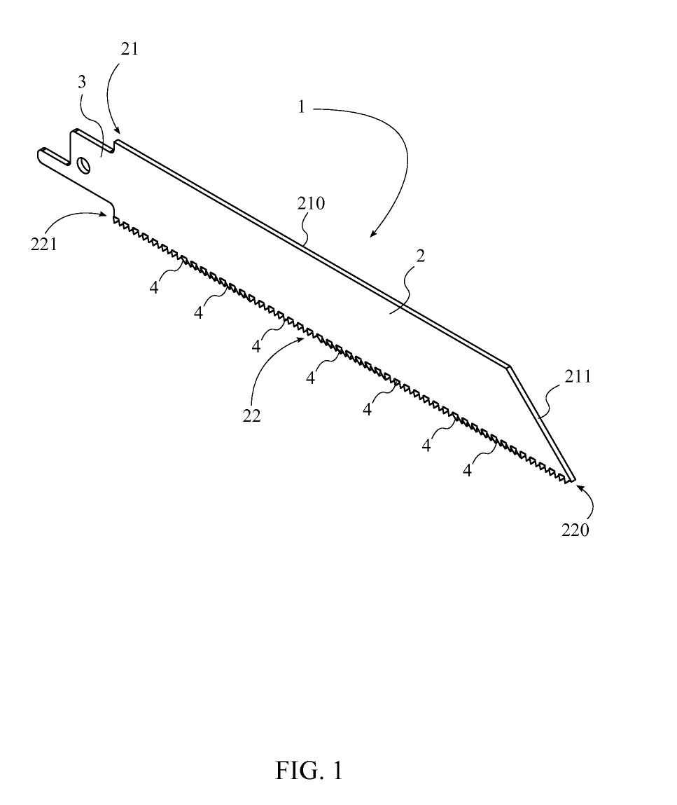

Referring to FIG. 1, in general, the present invention comprises a main body 1 and a plurality of teeth 4. The main body 1 comprises a blade portion 2 and at least one mounting portion 3. The blade portion 2 comprises a blunt edge 21 and a cutting edge 22. The cutting edge 22 comprises a front end 220 and a rear end 221 which are positioned opposite each other along the cutting edge 22. The blunt edge 21 and the cutting edge 22 form a perimeter of the blade portion 2. In the preferred embodiment of the present invention, the blunt edge 21 comprises a straight edge 210 and an angled edge 211. The straight edge 210 is oriented parallel to the cutting edge 22 and is positioned opposite the cutting edge 22 across the blade portion 2 from the cutting edge 22. The angled edge 211 is connected between the straight edge 210 and the cutting edge 22, adjacent to the front end 220. The angled edge 211 is an optional feature, typically used for saw blades which must pierce into the material surface in order to start a cut.

The at least one mounting portion 3 allows the present invention to be attached to a blade holder of a saw. In the preferred embodiment, the at least one mounting portion 3 is removably attached to a blade holder of a reciprocating saw, particularly a jigsaw. However, it is contemplated that many other types of saws may be utilized with the present invention, such as, but not limited to, a rip saw, a bow saw, a crosscut saw, a jab saw, or a hacksaw.

In the preferred embodiment of the present invention, the at least one mounting portion 3 is adjacently connected to the blunt edge 21 and the cutting edge 22 and is positioned between the blunt edge 21 and the cutting edge 22. Preferably, the at least one mounting portion 3 is a shank. The shank is a commonly known component of removable blades for reciprocating saws that allows the blade to be removably attached to the blade holder of the reciprocating saw. The shank is connected to the blade portion 2 adjacent to the rear end 221. The at least one mounting portion 3 may comprise a circular opening which is utilized to secure the present invention in place into a reciprocating saw.

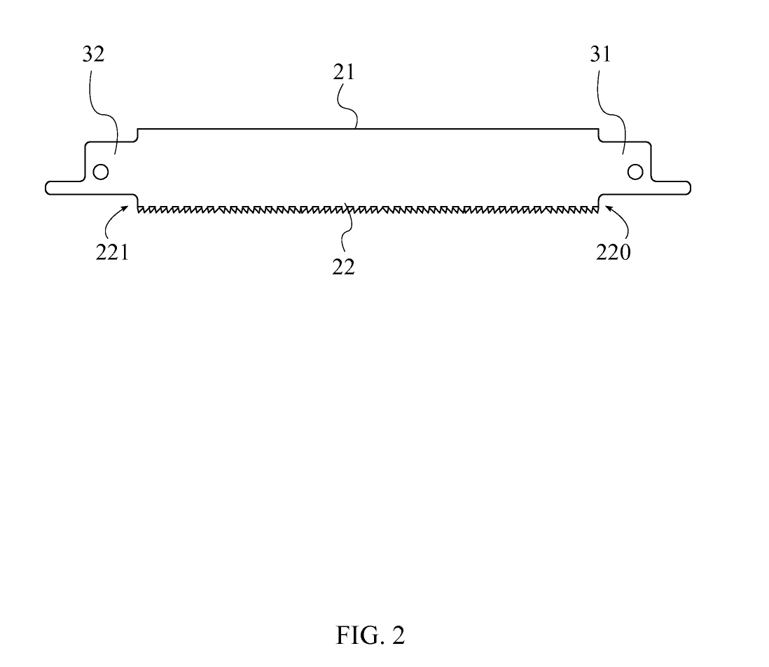

In one contemplated alternative embodiment shown in FIG. 2, the at least one mounting portion 3 comprises a first mounting portion 31 and a second mounting portion 32. In this embodiment, the first mounting portion 31 is connected to the blade portion 2 adjacent to the front end 220, and the second mounting portion 32 is connected to the blade portion 2 adjacent to the rear end 221. This embodiment illustrates such saw types as bow saws, hacksaws, or fretsaws.

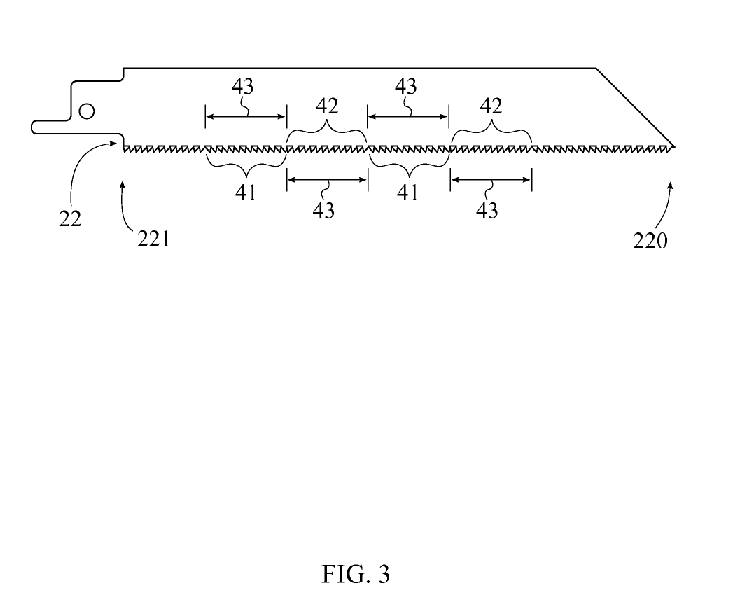

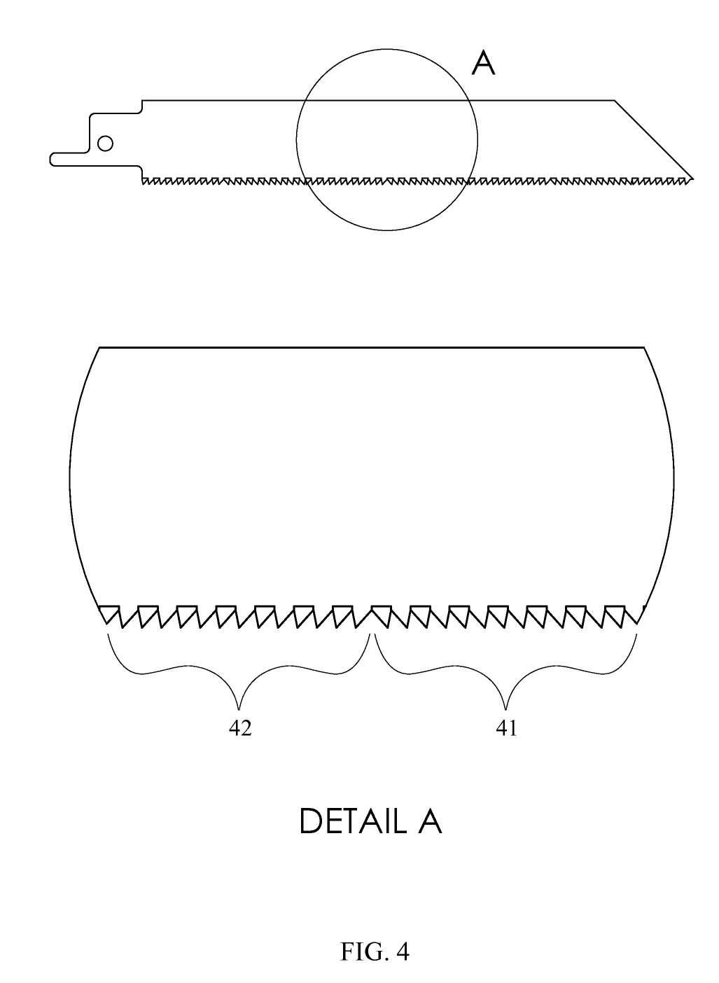

Referring to FIGS. 3-4, each of the plurality of teeth 4 is connected to the cutting edge 22. The plurality of teeth 4 comprises a plurality of forward-oriented teeth groupings 41 and a plurality of rearward-oriented teeth groupings 42, wherein the plurality of forward-oriented teeth groupings 41 are oriented towards the front end 220, and the plurality of rearward-oriented teeth groupings 42 are oriented towards the rear end 221. The plurality of forward-oriented teeth groupings 41 and the plurality of rearward-oriented teeth groupings 42 are alternatingly connected along the cutting edge 22; except for the teeth groupings adjacent to the front end 220 and the rear end 221 of the cutting edge 22, each forward-oriented teeth grouping is positioned between two rearward-oriented teeth groupings 42, and each rearward-oriented teeth grouping is positioned between two forward-oriented teeth groupings 41.

In the preferred embodiment of the present invention, each of the plurality of forward-oriented teeth groupings 41 and each of the plurality of rearward-oriented teeth groupings 42 traverse a specified length 43 along the cutting edge 22. The specified length 43 should correspond to a stroke length of the reciprocating saw the present invention is attached to in the preferred embodiment. The advantage of the specified length 43 corresponding to the stroke length has the result that a given portion of material in contact with the present invention will benefit from the cutting force of some of the forward-oriented teeth and some of the rearward-oriented teeth, ideally a full stroke length of both, depending on the placement of the material section along the blade. Stroke length varies among various models of reciprocating saws. Some common stroke lengths that the present invention may embody, but is not limited to, include: ¾ inch, 1 inch, 26 mm, 1⅛ inches, 1¼ inches, or 1½ inches.

In alternate embodiments, it is contemplated that the forward-oriented teeth groupings 41 and the rearward-oriented teeth groupings 42 may be of different lengths, or the teeth groupings may change in length according to position along the cutting edge 22. However, it is preferred that the forward-oriented teeth groupings 41 and the rearward-oriented teeth groupings 42 are the same length.

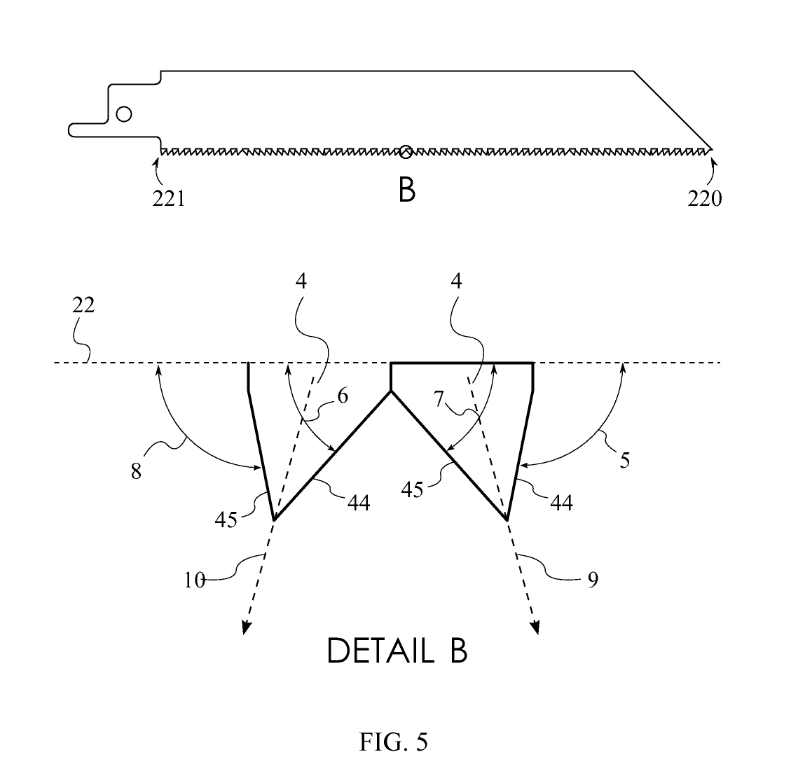

Referring to FIG. 5, in the preferred embodiment, each of the plurality of teeth 4 comprises a leading edge 44 and a trailing edge 45, which are both connected to the cutting edge 22 and preferably also connected to each other, forming a point as is typical with saw teeth. The leading edge 44 is positioned forward of the trailing edge 45; in other words the leading edge 44 is positioned closer to the front end 220 than the trailing edge 45, and the trailing edge 45 is positioned closer to the rear end 221 than the leading edge 44.

In order to more specifically define the forward-oriented teeth groupings 41 and the rearward-oriented teeth groupings 42, a first leading edge angle 5 is defined as a positive, clockwise angle, either acute or obtuse, from the cutting edge 22 to the leading edge 44 of the teeth from the forward-oriented teeth groupings 41. A first trailing edge angle 7 is defined as a positive, clockwise, acute angle from the cutting edge 22 to the trailing edge 45 of the teeth from the forward-oriented teeth groupings 41.

Similarly, a second leading edge angle 6 is defined as a positive, counterclockwise, acute angle from the cutting edge 22 to the leading edge 44 of the teeth from the rearward-oriented teeth groupings 42, and a second trailing edge angle 8 is defined as a counterclockwise angle, either acute or obtuse, from the cutting edge 22 to the trailing edge 45 for the teeth from the rearward-oriented teeth groupings 42.

The first leading edge angle 5 is greater than the first trailing edge angle 7. The second leading edge angle 6 is less than the second leading edge angle 6. This results in the forward orientation of the teeth from the forward-oriented teeth groupings 41 and the rearward orientation of the teeth from the rearward-oriented teeth groupings 42. Alternatively stated, a first imaginary line 9 pointing away from the cutting edge 22 and bisecting the leading edge 44 and the trailing edge 45 for the teeth from the forward-oriented teeth groupings 41 is angled toward the front end 220, and a second imaginary line 10 pointing away from the cutting edge 22 and bisecting the leading edge 44 and the trailing edge 45 for the teeth from the rearward-oriented teeth groupings 42 is angled toward the rear end 221.

Preferably, the teeth from the forward-oriented teeth groupings 41 are simply the reverse of the teeth from the rearward-oriented teeth groupings 42. Thus, the first leading edge angle 5 is equal to the second trailing edge angle 8, and the second leading edge angle 6 is equal to the first trailing edge angle 7. However, in alternate embodiments it is contemplated that the forward-oriented teeth groupings 41 and the rearward-oriented teeth groupings 42 may not be symmetrical, as desired.

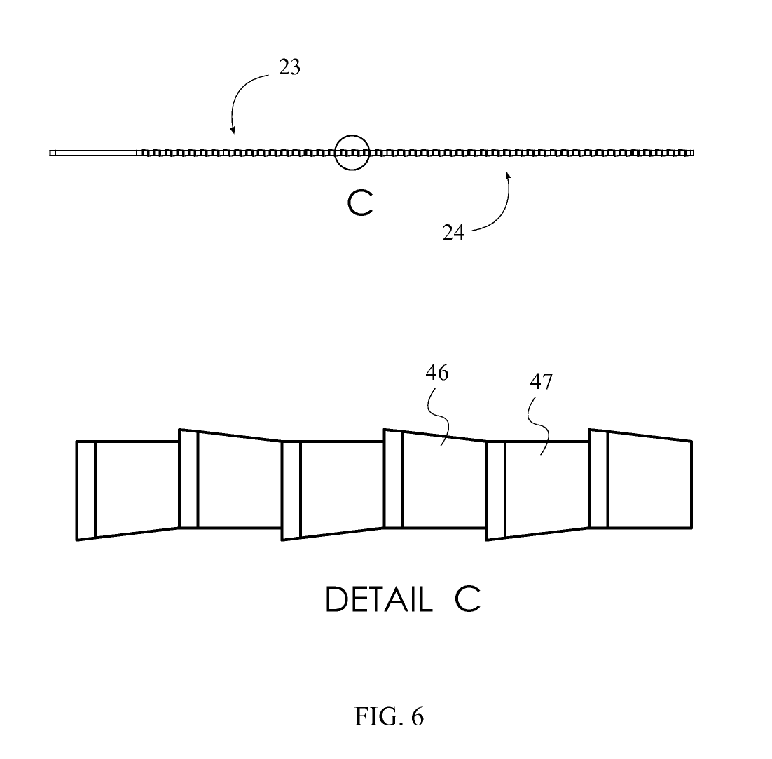

Referring to FIG. 6, the blade portion 2 further comprises a first lateral surface 23 and a second lateral surface 24, which are positioned parallel to each other and opposite each other across the blade portion 2. The first lateral surface 23 and the second lateral surface 24 are delineated by the cutting edge 22, the blunt edge 21, and the at least one mounting portion 3. Each of the plurality of teeth 4 is laterally skewed toward either the first lateral surface 23 or the second lateral surface 24.

In the preferred embodiment, an arbitrary tooth 46 and an adjacent tooth 47 from the plurality of teeth 4 are positioned adjacent to each other on the cutting edge 22. The arbitrary tooth 46 is laterally skewed toward the first lateral surface 23, and the adjacent tooth 47 is laterally skewed toward the second lateral surface 24. This is a commonly known manner of constructing a saw blade known as kerf. The kerf of a saw blade refers to the lateral distance between the outermost edges of the teeth due to being laterally skewed; the kerf of a saw blade is equal to the sum of the blade width and twice the set of the blade, which describes the distance the teeth protrude laterally. Kerf is utilized in order to create a wider cut then the thickness of the blade in order to give the blade room to operate within the cut.

Although the invention has been explained in relation to its preferred embodiment, it is to be understood that many other possible modifications and variations can be made without departing from the spirit and scope of the invention as hereinafter claimed.

What is claimed is:

1. A saw blade with alternatingly oriented teeth groupings comprises:
a main body;
a plurality of teeth;
the main body comprises a blade portion and an at least one mounting portion;
the blade portion comprises a blunt edge and a cutting edge;
the cutting edge comprises a front end and a rear end;
the plurality of teeth comprises a plurality of forward-oriented teeth groupings and a plurality of rearward-oriented teeth groupings, wherein the plurality of forward-oriented teeth groupings are oriented towards the front end, and wherein the plurality of rearward- oriented teeth groupings are oriented towards the rear end;
the blunt edge and the cutting edge forming a perimeter of the blade portion;
the at least one mounting portion being adjacently connected to the blunt edge;
the plurality of forward-oriented teeth groupings and the plurality of rearward-oriented teeth groupings being alternatingly connected along the cutting edge; and
each of the plurality of forward-oriented teeth groupings and each of the plurality of rearward-oriented teeth groupings traversing a specified length along the cutting edge.

2. The saw blade with alternatingly oriented teeth groupings as claimed in claim 1 comprises:
the at least one mounting portion being removably attached to a blade holder of a reciprocating saw; and
the specified length corresponding to a stroke length of the reciprocating saw.

3. The saw blade with alternatingly oriented teeth groupings as claimed in claim 1 comprises:
the blunt edge comprises a straight edge and an angled edge;
the straight edge being oriented parallel to the cutting edge;
the straight edge being positioned opposite the cutting edge across the blade portion; and
the angled edge being connected between the straight edge and the cutting edge adjacent to the front end.

4. The saw blade with alternatingly oriented teeth groupings as claimed in claim 1 comprises:
the at least one mounting portion being a shank; and
the shank being connected to the blade portion adjacent to the rear end.

5. The saw blade with alternatingly oriented teeth groupings as claimed in claim 1 comprises:
the at least one mounting portion comprises a first mounting portion and a second mounting portion;
the first mounting portion being connected to the blade portion adjacent to the front end; and
the second mounting portion being connected to the blade portion adjacent to the rear end.

6. The saw blade with alternatingly oriented teeth groupings as claimed in claim 1 comprises:
each of the plurality of teeth comprises a leading edge and a trailing edge;
the leading edge and the trailing edge being connected to the cutting edge; and
the leading edge being positioned forward of the trailing edge, wherein the leading edge is closer to the front end than the trailing edge, and wherein the trailing edge is closer to the rear end than the leading edge.

7. The saw blade with alternatingly oriented teeth groupings as claimed in claim 6 comprises:
a first leading edge angle being defined as a positive, clockwise angle from the cutting edge to the leading edge of the teeth from the forward-oriented teeth groupings;
a first trailing edge angle being defined as a positive, clockwise, acute angle from the cutting edge to the trailing edge of the teeth from the forward-oriented teeth groupings;
a second leading edge angle being defined as a positive, counterclockwise angle from the cutting edge to the leading edge of the teeth from the rearward-oriented teeth groupings; and
a second trailing edge angle being defined as a positive, counterclockwise, acute angle from the cutting edge to the trailing edge of the teeth from the rearward-oriented teeth groupings.

8. The saw blade with alternatingly oriented teeth groupings as claimed in claim 7 comprises:
the first leading edge angle being greater than the first trailing edge angle; and
the second leading edge angle being less than the second leading edge angle.

9. The saw blade with alternatingly oriented teeth groupings as claimed in claim 7 comprises:
the first leading edge angle being equal to the second trailing edge angle.

10. The saw blade with alternatingly oriented teeth groupings as claimed in claim 7 comprises:
the first trailing edge angle being equal to the second trailing edge angle.

11. The saw blade with alternatingly oriented teeth groupings as claimed in claim 1 comprises:
the blade portion further comprises a first lateral surface and a second lateral surface;
the first lateral surface and the second lateral surface being positioned parallel and opposite to each other across the blade portion;
the first lateral surface and the second lateral surface being delineated by the cutting edge and the blunt edge; and
each of the plurality of teeth being laterally skewed toward either the first lateral surface or the second lateral surface.

12. The saw blade with alternatingly oriented teeth groupings as claimed in claim 11 comprises:
an arbitrary tooth and an adjacent tooth from the plurality of teeth;
the arbitrary tooth and the adjacent tooth being positioned adjacent to each other on the cutting edge;
the arbitrary tooth being laterally skewed toward the first lateral surface; and
the adjacent tooth being laterally skewed toward the second lateral surface.
